(19) United States
(12) Patent Application Publication
(10) Pub. No.: US 2015/0189891 A1
(43) Pub. Date: Jul. 9, 2015

(54) Method and apparatus for cleaning baking surfaces

(71) Applicant: HAAS FOOD EQUIPMENT GMBH, Wien (AT)

(72) Inventors: Johannes Haas, Wien (AT); Josef Haas, Leobendorf (AT); Stefan Jiraschek, Koenigsbrunn (AT); Peter Buczolits, Stockerau (AT); Martin Kaller, Leobendorf (AT); Georg Kalss, Wien (AT)

(21) Appl. No.: 14/419,287

(22) PCT Filed: Aug. 1, 2013
(86) PCT No.: PCT/EP2013/066205

§ 371 Date: Feb. 3, 2015

(30) Foreign Application Priority Data
Aug. 3, 2012 (AT) A 863/2012

(51) Int. Cl. A21B 3/16

(52) U.S. Cl. CPC A21B 3/16

(57) ABSTRACT

A laser arrangement for cleaning one or more baking surfaces of a baking machine has a laser head and an interface for connection to the baking machine. The laser arrangement is coupled to the baking machine mechanically and/or by control technology. A baking machine with such a laser arrangement is described, as well as a method for cleaning baking surfaces wherein a laser head is disposed in the region of the baking surface of a baking machine. A laser beam is guided onto the baking surface for cleaning the baking surface and the treatment region of the laser arrangement is moved over the baking surface by relative movement between the laser head and the baking surface.

The invention relates to a method and an apparatus for cleaning baking surfaces, in particular for cleaning surfaces of baking plates, baking moulds or baking rings, for example, for producing flat wafers, hollow wafers, rolled cones, soft waffles, wafer rolls, wafer tubes etc. Furthermore, the invention relates to a baking machine for producing aforesaid or similar products which comprises one or more baking surfaces and at least one apparatus for cleaning the baking surfaces.

Furthermore, the invention relates to the use of the laser arrangement according to the invention for cleaning baking surfaces of the baking machines according to the invention.

Baking machines such as, for example, wafer baking machines for the industrial production of wafers comprise an oven section in which openable and closable baking tongs are guided driven in a circumferential manner. The batter to be baked or the baking mass to be baked is introduced between the baking plates of the baking tongs and baked under the action of temperature and optionally pressure. After the baking process, the baking tongs are opened and the ready baked wafers can be removed.

In practice the problem arises here that residue remains on the baking surfaces of the baking plates coming in contact with the batter or the baking mass. This residue contains, for example, oils, fat, starch-containing deposits, sugar deposits etc. At the present time, various methods are used to remove these deposits from the baking surfaces and clean these.

For example, the baking tongs are opened individually in a cleaning mode of the baking machine and brushed out by brushes. Another possibility corresponding to the prior art is the blowing out of the baking surfaces with compressed air.

During the cleaning of the baking surfaces a conflict of aims arises here between thorough cleaning and gentle treatment of the baking surfaces. For example, when brushing out baking surfaces it can occur that the surface is roughened or damaged. On the other hand during gentle treatment of the baking surfaces in many cases it is not possible to remove the stubborn incrustations or contaminants.

It is the object of the invention to provide an apparatus and a method for cleaning baking surfaces which reliably removes contaminants, encrustations, deposits etc. and in so doing causes no damage to the surface. It is further the object of the invention that the method and the apparatus can be used flexibly, in particular can be retrofitted in existing installations, can be supplied as a modular device if required or designed as an integral part of the baking machine. It is further the object of the invention to provide the fastest possible and uncomplicated cleaning possibility so that the production and the baking process need not be interrupted or only briefly. A further object of the invention is that the apparatus is favourable to manufacture and the method is favourable to execute.

The objects according to the invention can be subsumed under the term efficient cleaning of baking surfaces.

The object according to the invention is solved whereby an interface for connection to the baking machine is provided and the laser arrangement is coupled to the baking machine mechanically and/or by control technology. Furthermore, the objects according to the invention are solved by a method which is characterized in that a laser head is disposed in the region of the baking surfaces of a baking machine, a laser beam for cleaning the baking surfaces is guided onto the baking surface and through relative movement between the laser head and the baking surface the treatment region of the laser arrangement is moved over the baking surface.

It can further be provided according to the invention that the interface comprises a mechanical interface for coupling the laser arrangement to the baking machine and/or a control interface for coupling the control of the baking machine to the control of the laser arrangement, that a movement apparatus is provided for moving the laser head, that the laser head is movable along a first linear axis, a second linear axis and/or about a first axis of rotation, where the axes are in a predefined alignment to the baking surface(s) and/or the movement apparatus comprises a first support part for movement of the laser head along a first linear axis, a second support part for movement of the laser head along a second linear axis and/or a first axis of rotation for rotating or for swivelling the laser head.

The laser arrangement according to the invention is optionally characterized in that an optical recording unit and a data processing unit is provided for detecting the contamination and/or cleaning the baking surfaces.

Furthermore, the invention relates to a baking machine, where a laser arrangement is provided, where an interface for connection to the laser arrangement is provided, where the interface comprises a mechanical interface for coupling the laser arrangement to the baking machine and/or a control interface for coupling the control of the baking machine to the control of the laser arrangement, where the laser arrangement comprises a laser head from which laser radiation can be guided onto a treatment region on the baking surface and the laser head and the baking surface have at least one drivable degree of freedom relative to one another and/or where the baking surface and/or the laser head are drivable and movable by at least one drive. The baking machine is also characterized in that the laser head and/or the treatment region are movable along the baking surface, where the direction of movement differs from the direction of the baking movement and preferably runs transversely to this, that the baking machine is configured as an automatic baking tong machine and that the laser arrangement is provided in a region of the automatic baking tong machine in which the baking tongs are opened, that the laser arrangement is provided in the region of the pre-head, in the service region and/or in a reversal region, that the baking machine comprises at least one baking tong having a first and a second baking plate, that a first baking surface is provided on the first baking plate and a second baking surface is provided on the second baking plate and that for cleaning the first baking surface preferably has an opening angle of 40° to 120°, preferably greater than or equal to about 90°, with respect to the second baking surface and/or that the baking machine is designed as an annular baking machine.

The method optionally comprises the steps that the relative movement is achieved by movement of the baking surface and/or by movement of the laser head, that the laser head and/or the treatment region is moved transversely to the direction of baking movement of the baking surface, that the baking machine is configured as an automatic baking tong machine, that the cleaning region is provided in the region of the pre-head, in the service region or in the region of a turning point in which the baking tong and the baking surfaces are opened by, for example, 90° or more, that the laser head is positioned in the region of the baking surface, that the laser head is guided along the baking surface of the first baking plate until the entire surface is cleaned by the laser beam, that optionally the second baking surface of the second baking plate is cleaned with the laser head, that the baking tong is closed again, that the following baking plate is brought up to the cleaning region and/or that the method is repeated. Process steps according to the invention can also be that the laser arrangement is connected to the baking machine, that the laser head is swivelled about a first axis of rotation for cleaning the second baking plate, that data are recorded by an optical recording unit and are fed to a data processing unit for processing and/or for influencing the cleaning process and are optionally stored, that the data are used for detecting the degree of contamination and the contaminated locations of the baking surfaces and/or that the data are stored with assignment to a baking plate or a region of the baking surface and are supplied to a control device for controlling the laser head with respect to laser power.

The method optionally comprises the steps that the control for the laser head is connected to the control of the baking apparatus, that the data are used for controlling parameters such as the speed of advance, the laser intensity, the laser power, the size of the treatment region, the oscillation frequency and/or the oscillation amplitude and/or that the data are stored for documenting parameters such as the speed of advance, the laser intensity, the laser power, the size of the treatment region, the oscillation frequency and/or the oscillation amplitude.

For solving the objects according to the invention, a laser arrangement is used for cleaning the baking surfaces. In this case, any form of a laser arrangement can be used as laser arrangement which is suitable for removing the contamination from the baking surface. Preferably however commercially available industrial lasers are used. These for example have a strip-shaped or square beam cross-section. By oscillation the laser scans an approximately 120 mm wide strip of the baking surface. This strip corresponds to the treatment region of the laser arrangement. Depending on the width of the strip, it can be necessary that the baking surface is cleaned not in one but in several passes. If the width of the treatment region of the laser arrangement corresponds to the width of the baking plate, the treatment can also take place in one step.

Preferably fibre lasers, CO₂ lasers, YAG lasers, pulsed or in cw mode, are used. Examples of laser arrangements which may be used are a TEA-CO₂ Laser having a wavelength of 10.6 μm or a fibre laser having a wavelength of 1.06 μm.

The laser power can be between 20 and 500 watts in this case. The power is preferably about 100 to 200 watts. In practice, fibre lasers having a wavelength of 1.06 μm and a power of about 100 watts have proved particularly advantageous.

The laser power actually required is further dependent on the oscillation frequency, the oscillation amplitude, the type and degree of contamination.

The laser arrangement is connected or coupled according to the invention to a baking machine. To this end, both the baking machine and also the laser arrangement have an interface. The interface can on the one hand be a control interface and on the other hand a mechanical interface.

The control interface connects the means for controlling the laser arrangement and the means for controlling the baking machine to a control unit. In this case, a single control unit can be suitable and/or adapted for controlling the laser arrangement and the baking machine or respectively one control device for the laser arrangement and one control device for the baking machine can be provided. For example, the speed of the moving baking surfaces can be varied for cleaning. Furthermore, in automatic baking tong machines for example, the opening angle of the baking tongs can be increased or varied for cleaning. Furthermore, the control of the laser arrangement is also dependent on the degree of contamination and the speed of the baking surface. Thus, for example, control parameters such as the laser power, the oscillation frequency or the oscillation amplitude can be varied by means of the connection via the interface.

Furthermore, the interface optionally also relates to the mechanical connection and/or coupling of the laser arrangement on the baking machine. This interface is provided, for example, by conventional connection means such as screws, bolts, clamping devices, guide means etc. In principle, any connection means that can be used to produce an interface is suitable, in particular one which allows the desired positioning of a laser arrangement on the baking machine.

The laser arrangement and the interface can be provided according to the invention in one or more cleaning regions. That region in which the baking surfaces are cleaned by the laser arrangement is defined as cleaning region.

According to the invention, an optical detection arrangement is further provided. This comprises an image recording unit and an image analysis unit. The optical detection arrangement is used inter alia for determining the degree of contamination and the progress of cleaning and the attained degree of cleaning. If required, the data recorded by the detection arrangement can give an indication as to whether the cleaning of the baking surface has been sufficiently accomplished or whether another cleaning cycle must be carried out. Furthermore, the data on the cleaning progress and on the cleaning process can be stored. The storage of this data is used, for example, to create a cleaning protocol which helps to optimize the cleaning process. For example, as a result of the recorded and stored data, parameters such as the intensity of the laser, the speed of advance of the laser, the width of the laser strip and the oscillation frequency can be adapted. Furthermore, the recorded data can include the cleaning parameters of the apparatus such as, for example, the speed of advance, the laser intensity, the laser power, the size of the treatment region, the oscillation frequency, the oscillation amplitude etc. and consequently record the precise sequence of the cleaning process. The recorded data are preferably linked to data of the baking machine. Thus, for example, the cleaning process can be tracked for each individual one of the circulating baking plates. Furthermore, for example, in the case of elongated or annular baking surfaces, certain regions of stronger or weaker contamination can be identified. The optical detection arrangement can comprise optical filters such as, for example, polarization filters for clear image recognition, for example, of highly reflecting, chrome-plated surfaces. Furthermore, a cooling system can be provided for cooling the optical detection arrangement. However, the apparatus is preferably designed in such a manner that the temperature in the vicinity of or at the optical detection arrangement is so low that no cooling is required. An exemplary temperature which should not be exceeded is 80° C.

The optical detection arrangement is also used to detect the degree of contamination. The degree of contamination can be used as a parameter for regulating or controlling the cleaning process. Particularly highly contaminated regions can be exposed, for example, to laser radiation for longer or can be treated intensively by varying the oscillation frequency and/or amplitude.

In the method according to the invention, a high-intensity light beam, preferably a laser beam is directed onto the baking surface by the apparatus according to the invention. The baking surfaces are preferably formed from a metal body and have a smooth surface or predefined pattern-shaped relief structure. When the laser beam impinges upon the baking surface, a large part of the radiation is reflected. However when the laser beam impinges upon a contaminated location or a dirt particle, the laser beam is absorbed by the contamination. The energy is converted into thermal energy, whereby the dirt particle or the contaminated area is heated until combustion or evaporation takes place. Due to the different absorption or reflection properties of the contaminations and the baking surfaces, a particularly efficient and gentle cleaning is possible. The cleaning method is therefore a substantially thermal method.

Subsequently some applications of the apparatus according to the invention and the method according to the invention are now described.

According to a first embodiment, the laser arrangement according to the invention is provided on a baking machine with circulating, openable baking tongs. The baking tongs preferably comprise two baking surfaces. These each run on the inner side of the baking plates which are connected to one another in a hinge-like manner to form a baking tong. For baking wafers, for example, the batter is introduced into the opened baking tong. Subsequently the baking tong is closed and baked for a certain time at a certain temperature. At the end of the baking process the baking tongs are opened again to remove the ready baked wafer. The opening and closing of the baking tongs is accomplished, for example, by means of a linkage controller. For cleaning the baking surfaces the laser arrangement according to the invention is provided in the cleaning region in the region of the pre-head, i.e. in the region of the batter pouring. On passing through this region, the baking tongs are opened in order to perform the batter pouring in production operation. However, the baking machine also has a cleaning mode in which no batter is poured onto takes place. In the cleaning mode the laser arrangement is positioned in the vicinity of the baking plates in order to be able to guide the laser beam onto the desired region of the baking surface. To this end the laser arrangement can be designed as a modular removable module or it can be firmly connected to the frame of the baking machine. Preferably the laser head of the laser arrangement is disposed swivellably and/or displaceably. The displacement and the swivelling can be controlled and/or regulated by a control unit. Examples of drives are linear drives, rotary drives etc. By controlling the displacement and/or rotation of the laser head, any regions of the baking surface can be treated by the laser head. The laser head has a treatment region in which the laser can be moved in an oscillating manner. This working region can be guided over the entire baking surface to be treated. Furthermore, a laser arrangement can also be used, whose treatment region is substantially greater than or equal to the baking surface to be treated. In this case, the cleaning per baking surface takes place in one step. If the treatment region of the laser head is smaller than the surface to be treated, the baking surface will be cleaned in several steps or continuously. To this end a relative movement between the laser head and the baking surface is produced by drives. For cleaning the entire desired baking surface movement components can be achieved on the one hand by the movement of the baking tongs of the baking machine and also by a movement of the laser head by a movement arrangement.

In a further embodiment the laser arrangement is provided in the so-called service region of the baking machine. The cleaning region is located in the region of that turning point of the baking tongs which is further remote from the pouring region. In the service region the baking tongs are opened by a suitable control, e.g. a linkage control. The laser arrangement according to the invention either can again be attached temporarily for the cleaning process to the baking machine as a separate module or can be provided fixedly on said baking machine. Again the laser head is disposed movably and controllably/adjustably in order to achieve cleaning of the entire desired baking surface. In particular, a swivelling movement is possible in order to be able to treat both baking surfaces of the opened baking tongs. Preferably the baking tongs are opened about 90°. Consequently the laser head can also be swivelled substantially by 90° in order to change from treatment of the first baking surface to treatment of the second baking surface.

According to a third embodiment, a baking machine with circulating, openable baking tongs is also provided with a laser arrangement according to the invention. This is provided in the cleaning region in the region of the rear turning point, remote from the pouring region. In this embodiment, the baking tongs are guided opened by about 90° around the turning point. The laser head treats the baking surfaces in a substantially vertical position. That is, the principal direction of extension of both baking surfaces of a baking tong runs substantially vertically during cleaning by the laser arrangement.

According to a fourth embodiment the laser arrangement is disposed in the cleaning region of the front turning point. Similarly to the embodiment in which the laser arrangement is disposed in the region of the rear turning point, in the present embodiment the laser is directed onto at least one of the baking surfaces with opened baking tongs. The cleaning takes place with substantially vertical baking surfaces.

In all the four aforesaid embodiments of the apparatus according to the invention, the laser arrangement can either be connected fixedly to the baking machine or be added as a mobile unit as required.

According to the invention it can also be provided that the cleaning does not take place continuously but only during a special cleaning operation or a cleaning mode. In this embodiment the cleaning only takes place when the system is in the cleaning mode, i.e. the corresponding baking plate temperature is given for the specified cleaning interval. The operating data for the cleaning and laser setting data during the cleaning are recorded and stored.

The cleaning preferably takes already place at a time at which the baking plate only has slight contamination. It is thus ensured that the lowest possible laser power is required for the cleaning cycle. The intensity of the laser treatment must not lead to any impairment of the lifetime of the baking plates.

Furthermore, it is consistent with the inventive idea that the movable and/or modular laser arrangement is docked onto the baking machine and connected to the machine control. This modular unit can be used for several machines. The laser arrangement has an integrated protection device and an integrated suction device for split-off dirt particles and is coupled to the machine control.

As described, the laser arrangement is connected and/or connectable to the machine control. This enables parameters such as the speed of advance of the baking surfaces and the opening angle of the baking tongs and the control of the pouring of the batter to be adapted in a cleaning mode. Furthermore, safety-relevant parameters can be taken into account by means of the common control unit of the baking machine and the laser arrangement. Such safety-relevant parameters are, for example, whether the laser arrangement is connected correctly to the baking machine, whether the shielding elements are correctly positioned for shielding the laser arrangement and split-off dirt particles and/or whether for example the extraction is active.

In a preferred embodiment the cleaning is accomplished by the laser arrangement in a cleaning mode in which no regular operation of the baking machine is executed for producing baked products. The time of starting the cleaning mode can in this case be determined by parameters such as, for example, the hours of operation of the baking plates, the degree of contamination of the baking surfaces, the baking surface temperature etc.

Furthermore, the degree of contamination can also be taken into account by connecting the control of the laser arrangement to the control device of the baking machine. In the case of particularly severe contamination, the speed of advance of the baking surfaces can be slowed in order to be able to undertake more intensive cleaning. The degree of contamination can be determined, for example, by the optical recording unit.

Furthermore, as noted, the optical recording unit can also be used for documenting the cleaning progress. Thus, for example, each cleaned or each contaminated baking surface is photographed or filmed and the relevant image is stored for tracking. Furthermore, these images can also be evaluated immediately, where the results can be used for the laser control and for controlling the baking machine.

For cleaning the baking surfaces, as noted the laser head can be moved along several degrees of freedom. This movement corresponds, for example, to the linear movement along linear axes or rotation about 90° in order to be able to clean a baking tong opened, for example, by 90°. However, the movement of the laser head can be replaced in a similar manner by the provision of mirror deflections. For example, the laser head can be provided fixedly on the laser arrangement. Mirrors can be used for deflection of the laser beams. In particular, the rotation of the laser head about the axis of rotation can be replaced by the mirror arrangement. The linear axes for movement of the laser along a straight line or along a plane are retained in this case.

Usual opening angles of the baking tongs of baking machines are about 40° to 90°. Apparatus according to the invention are suitable for cleaning baking tongs with different opening angles, in particular in the region between 40° and 90°.

The invention will be explained further hereinafter with reference to exemplary embodiments.

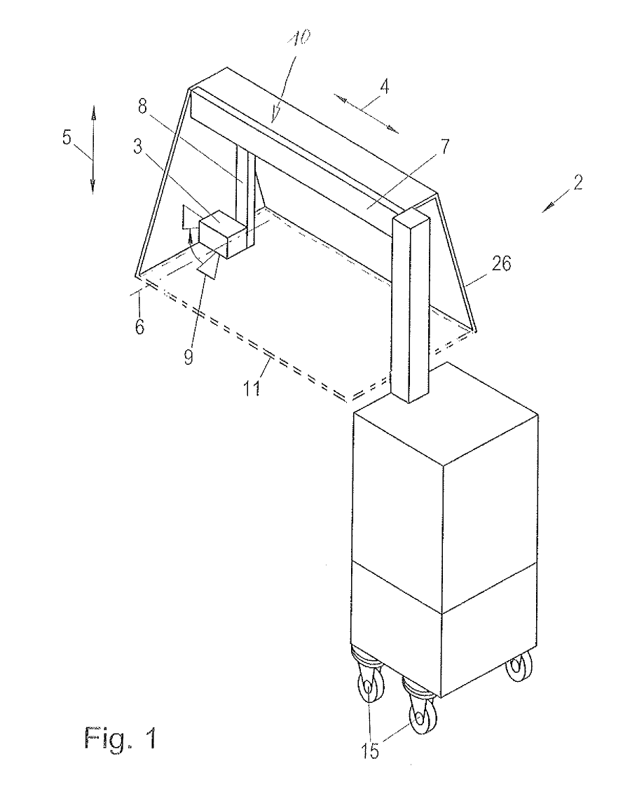

FIG. 1 shows a schematic oblique view of a laser arrangement according to the invention.

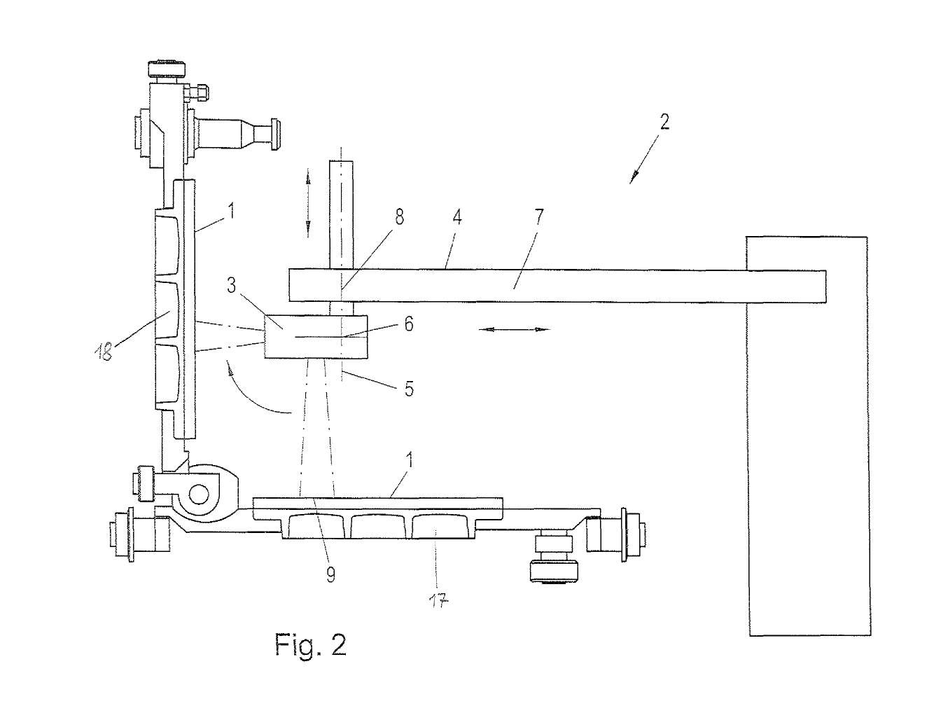

FIG. 2 shows a side view of a baking tong and a schematic view of the laser arrangement according to the invention.

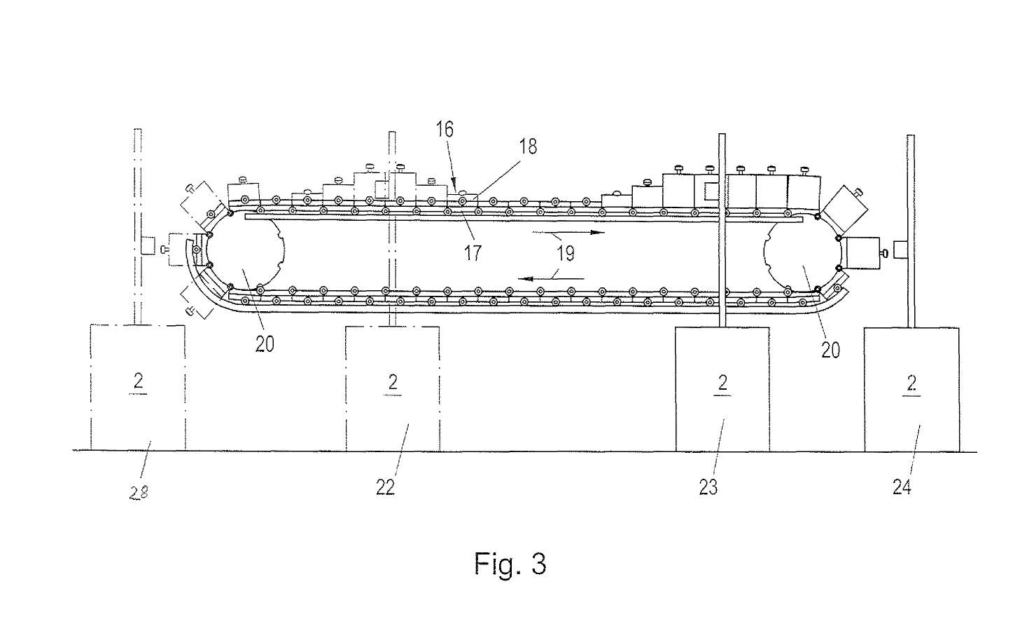

FIG. 3 shows a schematic side view of a possible embodiment of a baking oven with three possible positions of the laser arrangement.

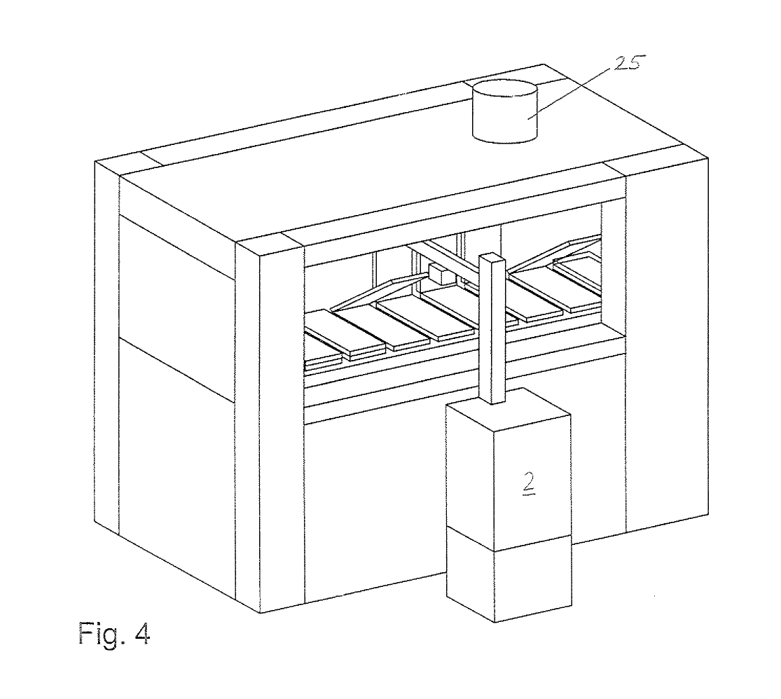

FIG. 4 shows a view of a possible baking machine with the laser arrangement according to the invention in an oblique view.

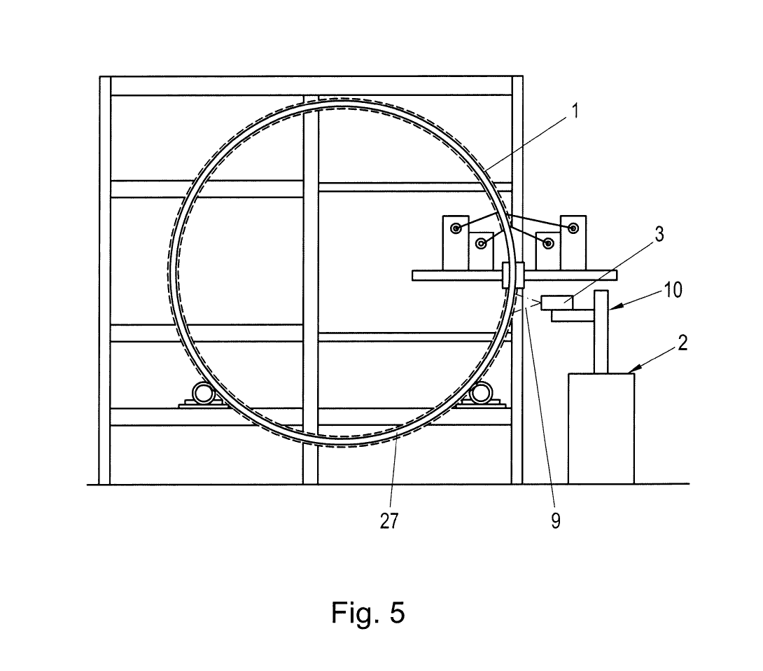

FIG. 5 shows another alternative embodiment of a baking machine with laser arrangement.

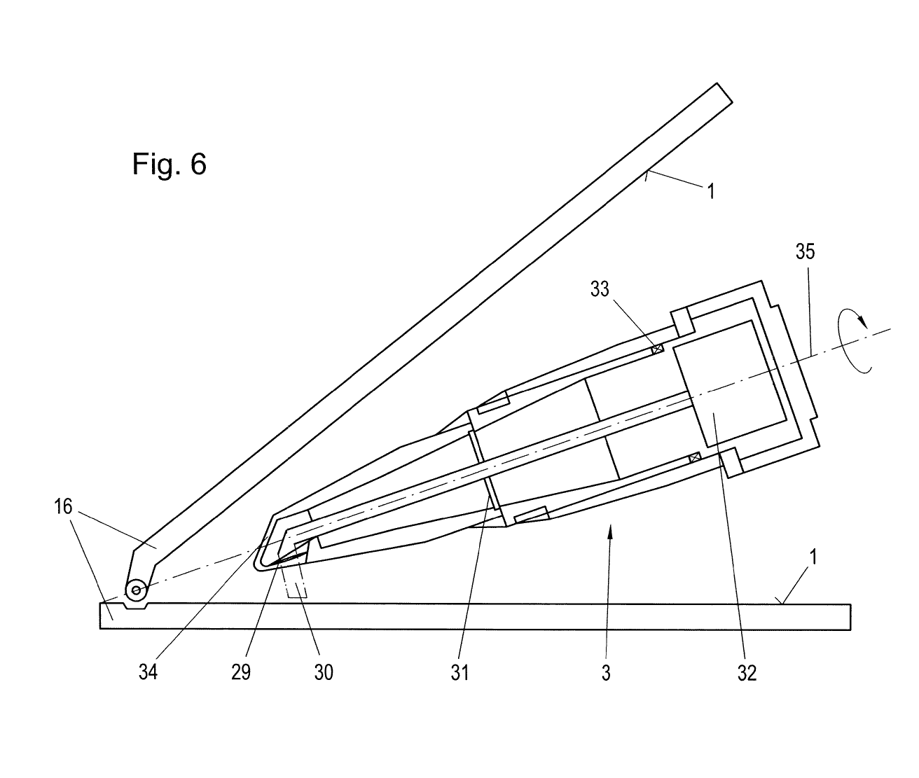

FIG. 6 shows schematically the arrangement of one embodiment of the laser head on a baking tong.

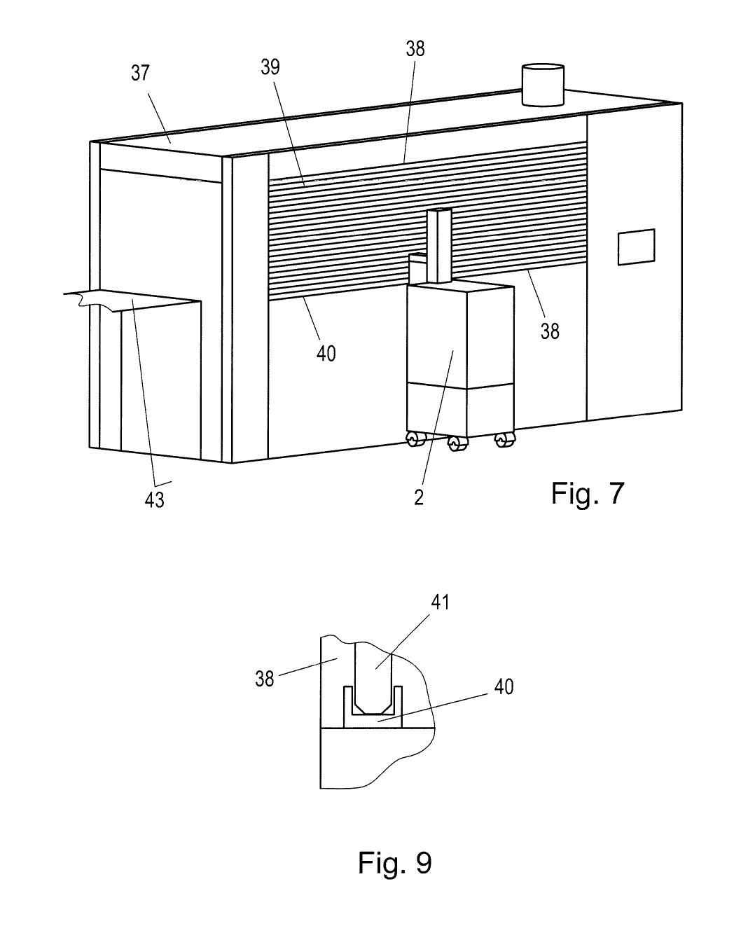

FIGS. 7 to 9 show schematically an oblique view, a section and a detailed view of a baking machine with a shielding.

FIG. 1 shows a schematic embodiment of a laser arrangement 2 with a laser head 3 which is disposed movably along several degrees of freedom. In the present embodiment the laser head 3 is disposed displaceably along a first linear axis 4 and along a second linear axis 5. The representation of the arrows is symbolic and indicates the displaceability along a first support part 7 and a second support part 8. Furthermore the laser head 3 is disposed swivellably and/or rotatably about the first axis of rotation 6. The laser head thus has three degrees of freedom which can preferably be driven in a controlled manner. It should be noted that the arrangement with two linear and one rotational degree of freedom is only one possible embodiment. Depending on the application, fewer, more or different degrees of freedom can be required. In order to simplify the description, the elements of the apparatus which are used for movement of the laser head 3 are combined under the designation movement arrangement 10. The movement of the laser head in this case relates to a relative movement with respect to the stationary parts of the apparatus or the baking oven or the baking machine. Another relative movement of the baking surfaces to be cleaned is optionally accomplished by movement of the baking surfaces themselves.

The laser head 3 has a treatment region 9. This is substantially predefined by the laser used. In the present case the treatment region 9 is executed as a strip-shaped region. The laser beam oscillates in this strip. If the treatment region 9 of the laser head 3 and/or the laser arrangement is smaller than the required deployment region 11 for cleaning the baking surface 1 to be cleaned, the laser head is moved relative to the baking surface 1 on the one hand by means of the movement arrangement 10 and/or on the other hand by means of the movement of the baking surface 1. The speed of movement is in this case dependent on several parameters. These parameters are, for example, the degree of contamination of the baking surface, the intensity of the laser radiation, the oscillation frequency, the oscillation amplitude and the distance of the laser head from the baking surface. An optical recording unit 13 is provided on the apparatus according to the invention for detecting the degree of contamination of the baking surface and for detecting the progress of cleaning. The signals of this optical recording unit 13, which for example is executed as an image recording device, can be supplied to a data processing unit 14. This data processing unit processes the data of the optical recording device and uses this data to control the cleaning process, in particular for controlling the laser head. This control can relate both to the power and intensity of the laser radiation, the oscillation frequency, the oscillation amplitude and the movement of the laser head relative to the baking surface. Furthermore, the control can also relate to the control of the baking machine itself, in particular the movement of the baking plates.

According to the invention, the laser arrangement can be firmly connected to the baking machine or the parts of the baking machine.

In a further embodiment the apparatus can be designed to be mobile in order to be brought to a specific position of the baking machine. With the design as a mobile, modular laser arrangement the advantage is furthermore obtained that the laser arrangement can be provided successively on a plurality of baking machines. Thus the laser arrangement can be used for cleaning a plurality of baking machines.

In order to further increase the flexibility of the laser arrangement, the laser head is disposed swivellably about at least the first axis of rotation 6. Due to this swivellability both horizontally running and also obliquely or perpendicularly running baking surfaces can be treated. In the present embodiment of FIG. 1, the laser arrangement is executed as floor-standing and self-supporting. It has wheels 15 in the region near the floor for movability of the laser arrangement.

In order to prevent an undesired escape of reflected laser radiation or dirt particles, a shield 26 is provided. This shield is preferably impenetrable for the laser. The shield 26 is depicted schematically. It extends in a bell shape over the deployment region 11 of the laser arrangement and/or over the baking surface to be cleaned.

The shield arrangement 26 is preferably designed in a bell shape and has an opening in the direction of the treatment region 9. In addition, another opening can be provided for suction of evaporated dirt components. To this end, a suction 25 is provided which further removes the vapour via a fan. The movement of the laser head 3 along the first linear axis 4 and the second linear axis 5 enables a relative movement of the laser head with respect to the baking surface. The first linear axis 4 runs substantially normally to the baking movement direction 19 and parallel to the principal direction of extension of the baking surface of the first baking plate 17. The second linear axis 5 runs substantially normally to the baking movement direction 19 and parallel to the principal direction of extension of the baking surface of the second baking plate 18. The first axis of rotation 6 runs substantially parallel to the baking movement direction 19 and parallel to the two principal directions of extension of the baking surface of the first and the second baking plate. The laser head can be moved by means of the linear axes 4, 5 and the first axis of rotation 6 therefore at least transversely to the baking movement direction 19. Another possibility for movement of the laser arrangement is the selection of the distance of the laser head with respect to the respective baking surface to be treated. Consequently, in the present embodiment the distance with respect to the baking surface and the positioning transverse to the baking movement direction 19 are determined by means of the movement arrangement 10. The treatment region 9 is executed in a strip shape, where the strip runs substantially normally to the baking movement direction 19 on the respective baking surface 1. The treatment region 9 can therefore be moved by means of the movement arrangement 10 substantially along a line, where the line runs in a normal plane with respect to the baking movement direction 19. In order to now achieve an extensive cleaning of the baking surface 1, another degree of freedom and another possibility for relative movement are provided. This is preferably accomplished by the movement of the baking tongs, i.e. the baking surfaces 1 themselves. The movement of the baking surface is accomplished in baking movement direction 19.

The opening angle of the baking tongs is preferably 90°. In principle however, other opening angles are possible in which the head can be positioned at a certain distance with respect to the baking surface.

In order to achieve a constant distance during the transverse movement with respect to the baking surface, it is advantageous if the linear axes 4, 5 are each disposed parallel to the respective baking surfaces. However, a distance regulation can also be accomplished by control of the linear axes.

FIG. 2 shows a schematic side view of an apparatus according to the invention for cleaning one or more baking surfaces 1. To this end, the laser head 3 of the laser arrangement 2 is disposed horizontally displaceably along a first linear axis 4 of the first support part 7 and/or parallel to the baking surface of the first baking plate 17. Preferably the laser head 3 is disposed vertically displaceably along a second linear axis 5 of the second support part 8 and/or parallel to the baking surface of the second baking plate 18. Furthermore, the laser head 3 is disposed rotatably about the first axis of rotation 6. In the present view the axis of rotation runs in a projecting manner. By turning the laser head by 90° and/or by an angle of 180° minus the opening angle of the two baking surfaces, the treatment region 9 of the laser head can be swivelled from the baking surface of the first baking plate 17 onto the baking surface of the second baking plate 18. In the present embodiment the two baking surfaces are executed as two baking surfaces of a conventional baking tong to produce wafers. For cleaning the two baking surfaces, the baking tong 16 containing the two baking plates 17, 18 is opened by about 90°. Such baking plates can preferably be used in wafer baking ovens in which the depicted schematic baking tong is moved along a baking movement direction 19. In the present view in FIG. 2 the baking movement direction 19 runs in a projecting manner. In the present embodiment the treatment region 9 of the laser head 3 or the laser arrangement 2 is smaller than the baking surface 1 to be treated. In order to nevertheless be able to achieve a cleaning of the entire baking surface 1, as described the laser head 3 is moved by the movement apparatus 10 in such a manner that the treatment region is positioned at least once at each point of the deployment region 11 to be cleaned. The treatment time, treatment speed, treatment intensity etc., is in particular dependent on the type of contamination and on the degree of contamination.

Parameters for controlling the cleaning process are, for example, recorded by the optical recording unit 13. Furthermore, these data can also be linked to empirical values and/or static values or are determined by these.

As in the previous embodiment, the laser head 3 is disposed movably parallel to the principal direction of extension of the baking surface 1. This movement is accomplished by means of the movement arrangement 10. The movement of the laser head both with respect to the principal direction of extension of the baking surface of the first baking plate 17 and also parallel to the baking surface of the second baking plate 18 is made possible by swivelling the laser head 3 about the first axis of rotation 6. This movement is accomplished, for example, in the plane of the diagram in FIG. 2. Another relative movement is again accomplished by means of the movement of the baking plates along the baking movement direction 19, which in this case runs in a projecting manner.

FIG. 3 shows a schematic side view of a baking machine, in particular a wafer baking machine. To this end, a plurality of baking tongs 16 comprising a first baking plate 17 and a second baking plate 18 are disposed along a baking movement direction 19. The baking tongs 16 are guided in a chain-shape circulating manner around two deflecting rollers 20. The baking plates can be opened or closed according to position or also independently of the position by means of a baking plate control device 21. In normal production operation the opening and closing of the baking tongs is used to introduce the baking mass to be baked or to remove the ready-baked body from the baking tong. Preferably the bodies to be baked are baked under the influence of a baking temperature with closed baking tongs. In the present embodiment, the baking tongs must also be opened for cleaning. Preferably the opening angle of the baking tongs is, for example, about 90°. This corresponds to the angle of the baking surfaces of the first baking plate 17 with respect to the baking surface of the second baking plate 18. Due to the 90-degree opening angle the laser head can be moved by displacement along two linear axes 4, 5 at an angle of 90° with respect to one another in such a manner that the treatment region 9 of the laser arrangement 2 can clean the entire deployment region 11, in particular the baking surface 1 to be cleaned.

The baking plate control device 21 is designed, for example, as a linkage control. To this end, running or control rollers of the baking plates are guided along space-curve-shaped elongate bodies in order to achieve the desired opening of the baking plates.

In one embodiment of the present invention a separate cleaning mode is provided for the cleaning. In this cleaning mode no baked bodies are produced on the baking surface 1 to be cleaned.

In the present view in FIG. 3 the laser arrangement 2 is provided at three possible exemplary positions. The first position 22 is located in the region of the pouring of the batter. The second possible position 23 for the laser arrangement 2 is located in the rear deflection region, in particular in the region of removal of the baked bodies. A third position 24 is located directly at the deflecting roller. In this region the baking surfaces 1 of both baking plates 17, 18 run substantially vertically.

Furthermore, a fourth position 28 of the laser arrangement 2 is shown. Similarly to the position 24, the laser arrangement is provided in the region of a turning point. The baking surfaces to be cleaned are substantially vertical during cleaning.

The cleaning of the baking surfaces 1 preferably takes place with a movement of the baking tongs in the baking movement direction 19. Other movement components and degrees of freedom of the laser head are provided by the movement along the first linear axis 4, the second linear axis 5 and by a rotation about the first axis of rotation 6. Consequently, together three linear, drivable degrees of freedom and one rotational drivable rotational degree of freedom are obtained in the present embodiment due to the movability of the movement arrangement 10 and the baking movement direction 19. Due to these four degrees of freedom, it is possible to execute the control of the laser head in such a manner that through movement of the treatment region 9, the entire desired deployment region 11 and/or the baking surfaces 1 to be cleaned can be cleaned.

FIG. 4 shows a schematic external view of an apparatus according to the invention with a baking machine according to the invention. The laser arrangement is located in a region in which the opening of the schematically depicted baking tongs 16 is sufficiently large to position the laser head 3 for cleaning the baking surfaces 1 therein. Preferably the opening is up to or more than 90°. The cleaning takes place substantially by severe heating and evaporation of the contamination on the baking surface. A suction 25 is provided for removal of vapour and residue.

FIG. 5 shows another embodiment of a baking machine which has a laser arrangement 2 for cleaning the baking surface 1. In the present embodiment of FIG. 5, the baking surface 1 runs along an annular heated baking ring 27. This baking ring is disposed rotatable and drivable about its central axis which in the present view runs in a projecting manner. For cleaning the cylindrical baking surface the laser arrangement is positioned in the region of the baking ring. The treatment region 9 of the laser arrangement 2 and the laser head 3 are movable by actuation of the movement arrangement 10. Again one movement component, i.e. the rotation of the baking surface 1 about the central axis of the baking ring 27 is given by the movement of the baking surface 1 itself. Another relative movement such as, for example, a movement of the laser head 3 and the treatment region 9 along a direction parallel to the central axis of the baking ring 27 can be given by a first linear axis 4.

Preferably the treatment region 9 runs in a strip shape on the baking surface 1. According to the present embodiment the strip runs substantially parallel to the central axis of the baking ring, i.e. projecting in the present view. As a result of a movement of the laser head 3 of the laser arrangement 2 by the movement arrangement 10, the laser head can be moved laterally and/or transversely to the direction of movement of the baking surface 1. In the present configuration this corresponds to a movement along an axis parallel to the axis of rotation of the baking ring.

According to another embodiment, the laser arrangement has an optical recording unit 13. The recorded data can be evaluated by the data processing unit 14 and according to the invention, influence parameters of the cleaning process. In this case, the movement of the laser head, the laser intensity and/or the oscillation frequency is dependent on the shape of the baking surface. In particular in the case of baking plates having a relief-type structure the contamination in depressions or grooves can be greater than in straight flat areas. Such shapes of the baking surface 1 are recognized by the optical recording unit 13 and specifically cleaned by suitable control of the baking machine and/or the laser arrangement. In particular, the coupling according to the invention is suitable for controlling the baking machines and the laser arrangement for shape-dependent cleaning of the baking surface. Also in the case of baking surfaces with deep depressions it can be necessary to adapt the focus and the direction of the laser according to the local shape of the baking surface. In particular, baking surfaces having relatively deep depressions are used to form hollow-body-shaped wafer bodies such as, for example, cones or hemispheres. The control according to the invention, the laser arrangement according to the invention and the baking machine according to the invention as well as the method according to the invention are suitable for cleaning such baking surfaces too. A further advantage of the shape-dependent control of the laser arrangement and the baking machine is the improvement in the efficiency of the cleaning method. Baking plates for forming wafer sheets for example have a grid-shaped, relief-like structure. The efficiency of the cleaning can be further improved by synchronizing the movement of the laser head and/or the laser beam with the shape of the baking surface.

FIG. 6 shows an embodiment of a laser head of the laser arrangement 2 according to the invention. The connection of the laser head 3 to further components of the laser arrangement 2 is not shown in this schematic diagram. According to one embodiment, the laser head shown is disposed, for example, in a first linear axis. As a further embodiment, two linear axes and in particular a second linear axis 5 can be provided in order to be able to move the laser head 3 both in the longitudinal and in the transverse direction of the moving baking plates.

In the present embodiment the baking surfaces 1 are provided on a baking tong 16. This baking tong 16 is opened. In particular, the opening angle approximately corresponds to that opening angle in which the batter pouring is performed in normal operation. The laser head 3 is configured in such a manner that a cleaning of the baking surfaces 1 of the baking tongs can take place in a position which corresponds to regular operation. To this end, the laser head is configured to be conically tapering and has a lens 29 at its front end through which the reading light or the laser beam 30 emerges. The laser head 3 further comprises an optics unit 31, a laser unit 32 and a mounting 33.

As in the preceding exemplary embodiments, with the laser head according to the invention it is possible to effect a focussing of the laser beam to different distances. In particular, with a relief-like structure of the baking surface 1 it may be necessary to improve the cleaning result by varying the focal width.

In particular, this is accomplished for example by moving the lens 29, by the optics unit 31 or by other optical components which are suitable for varying the focus of the laser beam.

In the present form the exit of the laser beam 30 is furthermore rotatable about an axis of rotation 35. In particular a 360° rotation of the laser beam is possible. As a result the laser beam can be pivoted laterally. Furthermore, the laser beam can be directed onto the upper baking plate, for example from the lower baking plate. The rotation of the laser beam 30 is accomplished, for example, by turning the mirror 34. This is inclined with respect to the laser beam at the exit from the laser unit 32 and deflects the laser beam 30. In particular, it deflects the laser beam 30 through the lens 29 onto the baking surface 1. By turning the mirror, the solid angle of the deflection can be varied. In the present embodiment the laser arrangement 2 or the laser head 3 has a mounting 33. This makes it possible to twist the mirror 34 with respect to the laser unit 32.

Advantageously according to this and further embodiments, the laser arrangement is characterized in that the focus of the laser beam can be varied and in particular that the focus can be varied according to the local shape of the baking surface.

According to a further embodiment, the laser arrangement can also be configured in such a manner that the laser beam is swivellable and/or rotatable about an axis of rotation. According to a preferred embodiment, the axis of rotation runs in a normal plane to the direction of transport or direction of movement of the baking surfaces 1. For example, in the case of a baking tong chain the axis can lie in the normal plane of the direction of movement of the baking tongs and point in the direction of the joint connecting the first and second baking plate. By rotating about the axis, the laser beam can thereby be directed onto the upper and/or the lower baking surface.

Preferably the rotatability is characterized in that it is 360° or more.

Combinations of the embodiments described are naturally possible and are consistent with the inventive idea. For example, a rotatable laser arrangement can be provided on one or more linear axes in order to increase the number of degrees of freedom.

Furthermore, a variability of the focus can also be provided in laser arrangements or laser heads with a rotatable laser beam.

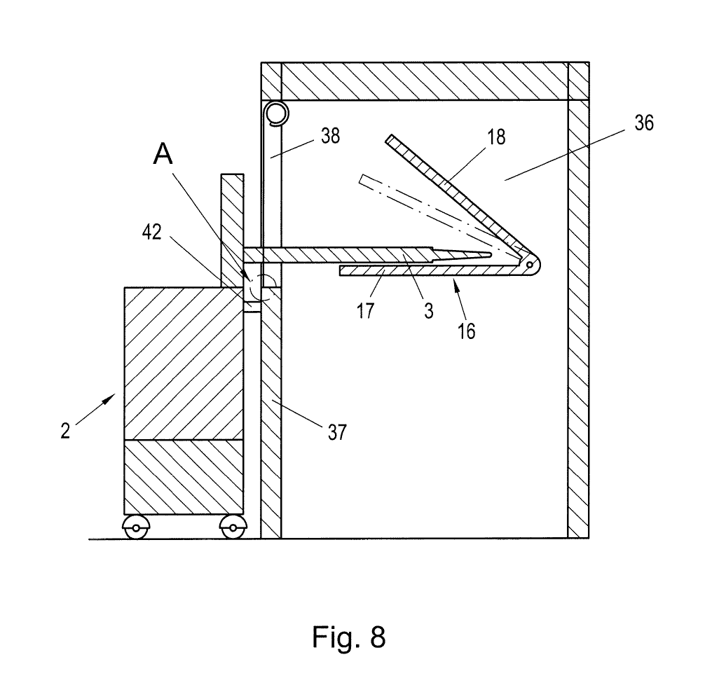

FIG. 7 shows the view of the oven front part (oven head of the baking machine) with docked laser arrangement 2, similar to FIG. 4. The front deflection of the baking plate chain is located in this section of the baking machine and the baking tongs are opened as can be seen in the sectional view in FIG. 8. On the right the oven head is adjoined by the oven body—not shown—usually having a lower installation height than the oven head. The rear deflection of the baking plate chain (not shown) is located at the oven end, as is known. On the left side the oven head is partially open and is there adjoined by a schematically depicted conveyor belt 43 to which the ready baked wafer sheets are transferred.

In order to shield any beams and avoid endangering persons, the baking machine is characterized in that the working region 36 of the laser arrangement 2 or in at least the beam region of the laser head 3 is shielded towards the outside.

According to FIGS. 7 to 9, the machine housing 37 is used for the shielding on the one hand and on the other hand the shielding is characterized in that an openable closure 39 is provided towards the front for the operating opening 38. Preferably the closure is a flap or particularly preferably a venetian blind or roller blind with the required shielding effect, as shown in FIGS. 7 and 8.

The lower edge 40 of the operating opening 38 advantageously has an upwardly open U-rail for receiving the lower edge 41 of the closure 39 in order to also make this sensitive region radiation-proof.

FIG. 8 shows with the reference number 42 the docking element in order to connect the laser arrangement to the baking machine both mechanically and also with respect to electrical control. Preferably the laser arrangement can only be released to deliver laser beams when correct docking has taken place and the closure is closed.

### REFERENCE LIST

1. Baking surface

2. Laser arrangement

3. Laser head

4. First linear axis

5. Second linear axis

6. First axis of rotation

7. First support part

8. Second support part

9. Treatment region

10. Movement arrangement

11. Deployment region

12.

13. Optical recording unit

14. Data processing unit

15. Wheels

16. Baking tongs

17. First baking plate

18. Second baking plate

19. Baking movement direction

20. Deflecting rollers

21. Baking plate control device

22. First position

23. Second position

24. Third position

25. Suction

26. Shielding

27. Baking ring

28. Fourth position

29. Lens

30. Laser beam

31. Optics unit

32. Laser unit

33. Mounting

34. Mirror

35. Axis of rotation

36. Working region

37. Machine housing

38. Operating opening

39. Closure

40. Edge of operating opening

41. Lower edge of closure

42. Docking element

43. Conveyor belt

1-31. (canceled)

32. In combination with an automatic baking tong machine having baking tongs to be opened, during an operation of the machine, in a pre-head region at which batter is poured, a laser arrangement for cleaning one or more baking surfaces of the baking machine, the laser arrangement comprising:
a laser head forming a part of a modular, removable laser arrangement module;
an interface for connecting the module to the baking machine, wherein the module is coupled to the baking machine mechanically and/or by control technology; and
wherein the laser arrangement is disposed in the pre-head region of the automatic baking tong machine in which the baking tongs are opened at which the batter is poured.

33. The laser arrangement according to claim 32, wherein said interface comprises a mechanical interface for coupling the laser arrangement to the baking machine and a control interface for coupling a control of the baking machine to a control of the laser arrangement.

34. The laser arrangement according to claim 32, which comprises a movement apparatus configured for moving said laser head.

35. The laser arrangement according to claim 34, wherein said laser head is movable along at least one of a first linear axis and a second linear axis, and/or about a first axis of rotation, wherein said axes are in predefined alignment to the one or more baking surfaces.

36. The laser arrangement according to claim 34, wherein said movement apparatus comprises a first support part for moving said laser head along a first linear axis, a second support part for moving said laser head along a second linear axis, and/or a first axis of rotation for rotating or for swiveling said laser head.

37. The laser arrangement according to claim 32, which comprises an optical recording unit and a data processing unit for detecting a contamination and/or a progress of cleaning of the baking surfaces.

38. . The laser arrangement according to claim 32 configured for cleaning one or more baking surfaces of the baking tongs of the baking machine, wherein said laser head is tapered in a forward direction towards a baking tong axis and said tapered laser head has a front end with a lens for exit of a laser beam.

39. The laser arrangement according to claim 38, wherein said laser head is configured such that a cleaning of the baking surfaces of the baking tongs can take place in a position which corresponds to a regular operation of the baking machine, wherein an opening angle of the baking tongs approximately corresponds to an opening angle at which the batter is poured in regular operation.

40. The laser arrangement according to claim 39, wherein said laser head is rotatably mounted about an axis of rotation and said laser head includes a mirror disposed for deflection of the laser beam.

41. The laser arrangement according to claim 32, wherein said laser head is configured to focus a laser beam onto the baking surface according to a respective distance therefrom.

42. The laser arrangement according to claim 32, wherein an opening angle of the baking tongs of the baking machine is between 40° and 90° and the apparatus is configured for cleaning baking tongs with different opening angles in the range from 40° to 90°.

43. A baking machine assembly, comprising:
a baking machine being an automatic tong baking machine with baking tongs and a pre-head at which the baking tongs are opened to perform batter pouring in a production operation;
a laser arrangement according to claim 32 for cleaning baking surfaces in the region of the pre-head of the baking machine;
wherein the baking machine has a cleaning mode in which no batter is poured, and wherein, in the cleaning mode, the laser arrangement is positioned in a vicinity of baking plates of the baking machine in order to be able to guide the laser beam onto a desired region of the baking surface for cleaning the baking surface.

44. The baking machine according to claim 32, which comprises at least one baking tong having a first and a second baking plate, said first baking plate having a first baking surface and said second baking plate having a second baking surface, and said at least one baking tong, for cleaning the first baking surface has an opening angle of 40° to 120° with respect to the second baking surface or the opening angle is 40° to 90°.

45. A method of cleaning a baking surface of a baking machine, the method comprising:
disposing a laser head in a region of the baking surface of the baking machine;
guiding a laser beam for cleaning the baking surface onto the baking surface;
moving a treatment region of the laser arrangement over the baking surface by a relative movement between the laser head and the baking surface; and
thereby effecting the relative movement by moving one or both of the baking surface and the laser head, and/or by moving the laser head and/or the treatment region transversely to a baking movement direction of the baking surface.

46. The method according to claim 45, wherein the baking machine is an automatic baking tong machine, and the method comprises:
defining a cleaning region in a region of the pre-head, wherein baking tongs and the baking surfaces are opened;
positioning the laser head in the region of the baking surface;
guiding the laser head along the baking surface of the first baking plate until an entire surface thereof is cleaned by the laser beam;
optionally cleaning the second baking surface of the second baking plate with the laser head;
subsequently closing the baking tong; and
bringing up a following baking plate to the cleaning region and repeating the process.

47. The method according to claim 45, wherein the laser arrangement is connected to the baking machine.

48. The method according to claim 45, which comprises, for cleaning the second baking plate, swiveling the laser head about a first axis of rotation.

49. The method according to claim 45, which comprises:
recording data by an optical recording unit and feeding the data to a data processing unit for processing and/or for influencing the cleaning process;
optionally storing the data;
utilizing the data for detecting a degree of contamination and determining contaminated locations of the baking surfaces; and
storing the data with assignment to a baking plate or a region of the baking surface and supplying same to a control device for controlling the laser head with regard to a laser power.

50. The method according to claim 49, wherein a control for the laser head is connected to a control of the baking machine.

51. The method according to claim 49, which comprises using the data for controlling parameters selected from the group consisting of a speed of progress, a laser intensity, a laser power, a size of the treatment region, an oscillation frequency, and an oscillation amplitude.

52. The method according to claim 49, which comprises storing the data for documenting parameters selected from the group consisting of a speed of progress, a laser intensity, a laser power, a size of the treatment region, an oscillation frequency, and an oscillation amplitude.
